(19) United States
(12) Patent Application Publication
(10) Pub. No.: US 2025/0326253 A1
(43) Pub. Date: Oct. 23, 2025

(54) APPARATUS AND METHOD CONFIGURED TO DETACH A CRAWLER FROM A SURFACE USING A WHEEL TILTING WIRE MECHANISM

(71) Applicant: SAUDI ARABIAN OIL COMPANY, Dhahran (SA)

(72) Inventors: Fadl Abdellatif, Thuwal (SA); Ahmed Al Brahim, Thuwal (SA); Amjad Felemban, Thuwal (SA); Yousef Damanhouri, Thuwal (SA)

(73) Assignee: SAUDI ARABIAN OIL COMPANY, Dhahran (SA)

(21) Appl. No.: 18/643,415

(22) Filed: Apr. 23, 2024

(51) Int. Cl. B60B 35/00; B60B 19/00

(52) U.S. Cl. CPC B60B 35/009; B60B 19/006

(57) ABSTRACT

An apparatus and method detach a crawler having a magnetic wheel from a surface of a structure using a wheel tilting wire mechanism. A portion of the magnetic wheel magnetically adheres to the surface of the structure. The apparatus includes a platform engaging the crawler. Movement of the wire by the platform pivots or tilts an axle of the magnetic wheel to lift a portion of the wheel away from the surface of the structure, thereby reducing the magnetic adhesion of the wheel to the surface of the structure. Based on the reduced magnetic adhesion, the platform detaches the magnetic wheel from the surface of the structure, and detaches the crawler from the platform. The method implements operation of the apparatus.

### FIELD OF THE DISCLOSURE

The present disclosure relates generally to crawlers for inspecting structures, and, more particularly, to an apparatus and method configured to detach a crawler from a surface of a structure using a wheel tilting mechanism employing wires.

### BACKGROUND OF THE DISCLOSURE

Robots and other autonomous or semi-autonomous devices have been developed for the inspection, maintenance, and cleaning of various structures in diverse environments, such as oil and gas pipelines. Some robots are configured to fly towards, perch on, and inspect such structures. Other robots even carry and then deploy other robots, typically crawlers released from a primary vehicle capable of flight. By using crawlers moving along surfaces of structures, the range and capabilities of robot technology has significantly increased.

Robots including crawlers with magnetic wheels enable such devices to adhere to various ferromagnetic surfaces as well as to crawl and climb on the surfaces. However, in order to prevent such robots from becoming inadvertently disengaged or to slip from ferromagnetic surfaces, wheels with powerful magnets are employed to establish a magnetic coupling or adhesion between the wheels and the ferromagnetic surfaces. Although the inadvertent disengagement of robots from surfaces is addressed by using powerful magnets, removing robots equipped with such powerful magnets from ferromagnetic surfaces requires a large amount of force. Since robots are implemented using batteries and other limited and portable power sources, the necessary energy required to provide such a large amount of force to pry off and detach robots from a surface is prohibitive in relation to the limited power capacity of a robot.

### SUMMARY OF THE DISCLOSURE

According to an implementation consistent with the present disclosure, an apparatus and method are configured to detach a crawler from a surface of a structure using a wheel tilting mechanism employing wires, and to attach the crawler to the surface of the structure using a magnetic wheel magnetically coupled to the surface.

In an implementation, a crawler is configured to move along a surface of a structure. The crawler comprises a body, a pair of wheels, and a pair of side members. The body includes a wire having a pair of ends, and a pair of pivot points. Each of the pair of wheels includes an axle and an outer surface having a magnetic component and configured to move adjacent to the surface of the structure, wherein the magnetic component establishes a magnetic adhesion of a respective wheel to the surface of the structure. Each of the pair of side members is coupled to a respective end of the wire, wherein each side member is coupled to a respective axle of a respective wheel. Each side member is pivotally coupled to a respective pivot point. Responsive to a device moving the wire away from the surface of the structure in a first movement, the pair of side members pivot about the respective pivot points to pivot the respective axle. Responsive to the pivoting of each axle, a portion of the outer surface of one of the pair of wheels corresponding to the respective axle pivots away from the surface of the structure, thereby reducing the magnetic adhesion of the wheel to the surface of the structure. Responsive to the device moving the wire away from the surface of the structure in a second movement, the device overcomes the reduced magnetic adhesion and detaches at least one of the pair of wheels from the surface of the structure to allow removal of the crawler from the surface of the structure.

The wire can be configured to removably couple to a fastener of the device using a mechanical coupling or a magnetic coupling. A movement of the fastener can move the wire in the first movement, thereby pivoting the pair of side members about the respective pivot points to pivot the respective axles. The wire can include a pair of wires, wherein one end of each wire can be mounted to the body, and wherein the other end of each wire can be coupled to a respective side member. Responsive to the device moving at least one of the pair of wires away from the surface of the structure in the first movement, at least one of side members can pivot about a respective pivot point to pivot the respective axle. The body can include a wire guide configured to receive and pass the wire through the wire guide. The crawler can further comprise a mounting member configured to retain the wire guide. The crawler can further comprise a pair of wire stoppers each retained by a respective wire of the pair of wires, including a strained wire and a loose wire, with each of the strained wire and the loose wire is associated with a respective side member and a respective wheel.

Responsive to the device moving the strained wire away from the surface of the structure in the second movement, the device can overcome the reduced magnetic adhesion and can detach the wheel associated with the strained wire from the surface of the structure to allow removal of the crawler from the surface of the structure. Responsive to the device moving the wire away from the surface of the structure in a third movement, the side member associated with the loose wire can pivot about a respective pivot point to pivot the respective axle, thereby pivoting the portion of the outer surface of the respective wheel corresponding to the respective axle to pivot away from the surface of the structure, thereby reducing the magnetic adhesion of the respective wheel to the surface of the structure.

In another implementation, an apparatus comprises a platform and a crawler. The platform includes an actuator having a base and a telescoping member configured to extend from or retract into the base. The crawler is configured to move along a surface of a structure. The crawler includes a body, a pair of wheels, and a pair of side members. The body includes a wire having a pair of ends, and a pair of pivot points. Each wheel of the pair of wheels includes an axle and an outer surface having a magnetic component and configured to move adjacent to the surface of the structure, wherein the magnetic component establishes a magnetic adhesion of a respective wheel to the surface of the structure. Each side member of the side members is coupled to a respective end of the wire, wherein each side member is coupled to a respective axle of a respective wheel, and wherein each side member is pivotally coupled to the pivot point.

Responsive to the actuator moving the wire away from the surface of the structure in a first movement, the pair of side members pivot about the respective pivot points to pivot the respective axle. Responsive to the pivoting of each axle, a portion of the outer surface of one of the pair of wheels corresponding to the respective axle pivots away from the surface of the structure, thereby reducing the magnetic adhesion of the wheel to the surface of the structure. Responsive to the actuator moving the wire away from the surface of the structure in a second movement, the actuator overcomes the reduced magnetic adhesion and detaches at least one of the pair of wheels from the surface of the structure to allow removal of the crawler from the surface of the structure.

The wire can be configured to removably couple to a fastener of the actuator using a mechanical coupling or a magnetic coupling. A movement of the fastener can move the wire in the first movement, thereby pivoting the pair of side members about the respective pivot points to pivot the respective axles. The wire can include a pair of wires, wherein one end of each wire cam be mounted to the body. The other end of each wire can be coupled to a respective side member. Responsive to the actuator moving at least one of the pair of wires away from the surface of the structure in the first movement, at least one of side members can pivot about a respective pivot point to pivot the respective axle.

The body can include a wire guide configured to receive and pass the wire through the wire guide. The apparatus can further comprise a mounting member configured to retain the wire guide. The apparatus can further comprise a pair of wire stoppers each retained by a respective wire of the pair of wires, including a strained wire and a loose wire, with each of the strained wire and the loose wire is associated with a respective side member and a respective wheel. Responsive to the actuator moving the strained wire away from the surface of the structure in the second movement, the actuator can overcome the reduced magnetic adhesion and detaches the wheel associated with the strained wire from the surface of the structure to allow removal of the crawler from the surface of the structure. Responsive to the actuator moving the wire away from the surface of the structure in a third movement, the side member associated with the loose wire can pivot about a respective pivot point to pivot the respective axle, thereby pivoting the portion of the outer surface of the respective wheel corresponding to the respective axle to pivot away from the surface of the structure, thereby reducing the magnetic adhesion of the respective wheel to the surface of the structure.

In a further implementation, a method comprises moving a crawler along a surface of a structure, wherein the crawler includes a magnetic wheel magnetically adhering to the surface. The method further comprises engaging a wire of the crawler and a fastener of a platform in a coupling, moving the coupling of the wire and the fastener towards the platform, and responsive to the moving of the wire in the coupling, moving a portion of the magnetic wheel away from the surface of the structure, thereby reducing the magnetic adhesion of the magnetic wheel to the surface of the structure. The method further comprises moving the combination of the crawler and the platform away from the surface of the structure.

The coupling of the wire and the fastener can be a removable coupling. Moving the portion of the magnetic wheel away from the surface of the structure can include tilting the magnetic wheel about a pivot point. Moving the coupling of the wire and the fastener towards the platform can include retracting a telescopic member of an actuator, wherein the fastener can be attached to an end of the telescopic member.

Any combinations of the various embodiments, implementations, and examples disclosed herein can be used in a further implementation, consistent with the disclosure. These and other aspects and features can be appreciated from the following description of certain implementations presented herein in accordance with the disclosure and the accompanying drawings and claims.

### BRIEF DESCRIPTION OF THE DRAWINGS

FIG. 1 is a top front side perspective view of an apparatus including a crawler and a platform, according to an implementation.

FIG. 2 is a side elevational view of the apparatus of FIG. 1 with the crawler approaching the platform.

FIG. 3 is a side elevational view of the apparatus of FIG. 1 with the crawler coupled to the platform.

FIG. 4 is a top front side perspective view of the apparatus of FIG. 1 with the platform using a fastener on an actuator to engage a wire of the crawler.

FIG. 5 is a top front side perspective view of the apparatus of FIG. 1 with the platform using an actuator to pull the wire upward.

FIG. 6 is a top front side perspective view of the apparatus of FIG. 1 with the pulling of the wire tilting the wheels of the crawler.

FIG. 7 is a top front side perspective view of the apparatus of FIG. 1 with the apparatus and crawler moving away from the surface.

FIG. 8 is a top front side perspective view of an apparatus including a crawler and a platform, according to an alternative implementation.

FIG. 9 is a side elevational view of the apparatus of FIG. 8 with the crawler approaching the platform.

FIG. 10 is a side elevational view of the apparatus of FIG. 8 with the crawler coupled to the platform.

FIG. 11 is a front elevational view of the apparatus of FIG. 10 with one actuator and a corresponding fastener of the platform lifting one wire to tilt a corresponding wheel of the crawler.

FIG. 12 is a front elevational view of the apparatus of FIG. 8 with another actuator and a corresponding other fastener of the platform lifting another wire to tilt a corresponding wheel of the crawler.

FIG. 13 is a top front side perspective view of the apparatus of FIG. 8 with the platform rotating actuate members connected to the lifted wires to tilt the wheels of the crawler.

FIG. 14 is a top front side perspective view of the apparatus of FIG. 8 with the apparatus and crawler moving away from the surface.

FIG. 15 is a top front side perspective view of an apparatus including a crawler and a platform, according to a further alternative implementation.

FIG. 16 is a side elevational view of the apparatus of FIG. 15 with the crawler approaching the platform.

FIG. 17 is a side elevational view of the apparatus of FIG. 15 with the crawler coupled to the platform.

FIG. 18 is front elevational view of the apparatus of FIG. 17 with the platform using a fastener on an actuator to pull a wire of the crawler to pull a strained wire side.

FIG. 18A is front elevational view of the apparatus of FIG. 18 with the platform using a fastener on an actuator to pull a loop of a wire of the crawler.

FIG. 18B is front elevational view of the apparatus of FIG. 18 with the platform using a fastener on an actuator to pull a shortened wire of the crawler.

FIG. 19 is a front elevational view of the apparatus of FIG. 18 with a magnetic wheel tilted after pulling the strained wire side.

FIG. 20 is a front elevational view of the apparatus of FIG. 19 with a magnetic wheel tilted after pulling a loose wired side.

FIG. 21 is a top front side perspective view of the apparatus of FIG. 20 with the pulled strained and loose wires sides for tilting the wheels of the crawler.

FIG. 22 is a top front side perspective view of the apparatus of FIG. 21 with the platform and the crawler moving away from the surface.

FIG. 23 is a flowchart of operation of a crawler detaching from a surface, according to an implementation.

FIG. 24 is a flowchart of operation of a crawler attaching to a surface, according to another implementation.

It is noted that the drawings are illustrative and are not necessarily to scale.

### DETAILED DESCRIPTION OF CERTAIN EMBODIMENTS OF THE DISCLOSURE

Example embodiments and implementations consistent with the teachings included in the present disclosure are directed to an apparatus and method are configured to detach a crawler from a surface of a structure using a wheel tilting wire mechanism, and to attach the crawler to the surface of the structure using a magnetic wheel magnetically coupled to the surface.

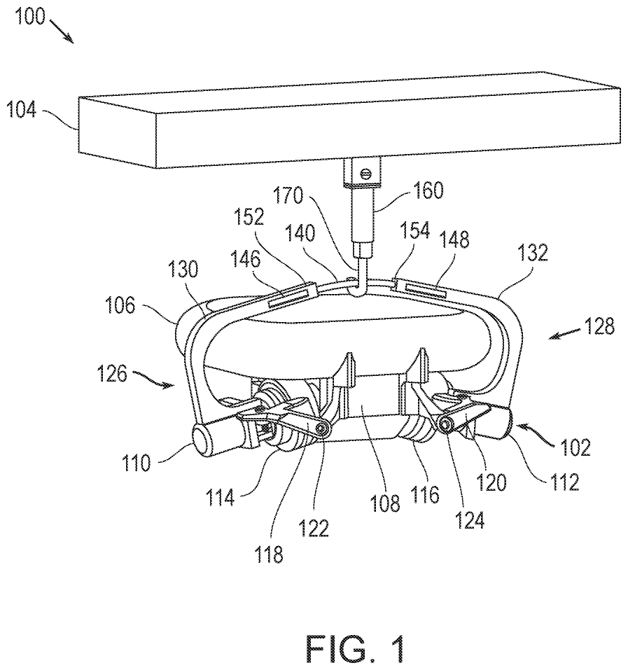

Referring to FIGS. 1-7, an apparatus 100 includes a crawler 102 and a platform 104, according to an implementation consistent with the invention. The crawler 102 includes a chassis or body 106 and a sub-assembly 108. In one implementation, the sub-assembly 108 includes a probe configured to inspect the surface along which the crawler 102 moves. For example, the probe in the sub-assembly 108 is an ultrasound emitter and detector. In another example, the probe is an electromagnetic emitter and detector, such as camera with a light. The probe is configured to inspect the physical surface of the structure or to inspect the structure itself, for example, for cracks, rust, or other corrosion. In another implementation, the sub-assembly 108 includes any known payload included in or coupled to the crawler 102.

Referring to FIG. 1, the body 106 includes a housing having an interior to retain electronics. In one implementation, the crawler 102 includes a robot, a walker, or other known vehicles, such as described in U.S. Pat. No. 11,235,823, which is incorporated herein by reference in its entirety. In addition, the body 106 also includes a pair of side members 110, 112, with each side member 110, 112 rotatably coupled to an axle of a wheel 114, 116, respectively. Each wheel 114, 116 is configured to rotate about a respective axle. Each side member 110, 112 is attached to an arm 118, 120, respectively. In one implementation, the crawler 102 includes at least one wheel. In another implementation, the crawler 102 includes a pair of wheels 114, 116 disposed on opposite portions of the crawler 102, such as opposite sides of the crawler 102 as shown in FIG. 1. In a further implementation, the crawler 102 includes four wheels. In an implementation consistent with the invention, the wheels 114, 116 are composed of a magnetic material. In one implementation, at least the outer surfaces of the wheels 114, 116 are composed of magnetic material. For example, the wheels 114, 116 are permanent magnets. In another example, the wheels 114, 116 are electromagnets, with at least an electronic switch and a power source disposed in the body 106 to activate and deactivate the magnetism of each wheel 114, 116. In such examples, the magnetic wheels 114, 116 are configured to be magnetically attracted to magnetic structures. As described below, the crawler 102 with the magnetic wheels 114, 116 is configured to move along a surface of a structure. In one implementation, the surface includes a ferromagnetic composition, such as iron. In another implementation, the surface includes any known materials configured to be magnetically attracted and coupled to the magnetic wheels 114, 116. Such magnetic attraction between a surface and the wheels 114, 116 of the crawler 102 allows the crawler 102 to be removably held against the surface and to move adjacent to the surface, including curved surfaces, tilted surfaces, vertical surfaces, etc. without detaching.

A first assembly of the side member 110, the magnetic wheel 114, and the arm 118 is pivotally attached to the body 106 by a pivot point 122 as a first wheel rotation anchor. Similarly, a second assembly of the side member 112, the magnetic wheel 116, and the arm 120 is pivotally attached to the body 106 by a pivot point 124 as a second wheel rotation anchor. Accordingly, the first and second assemblies pivot about the pivot points 122, 124, respectively, which tilts the magnetic wheels 114, 116 and reduces the magnetic coupling or adhesion of the magnetic wheels 114, 116 to the surface 200.

In one implementation, each side member 110, 112 includes an arcuate member 126, 128, respectively, with the arcuate members 126, 128 curving around a side of the body 106 and over a top portion of the body 106. The arcuate members 126, 128 have upper portions 130, 132 extending over the top portion of the body 106. A wire 140 extends over the top of the body 106. For example, the wire 140 is a cable or other elongated and flexible material having a relatively strong tensile strength. In one implementation, the wire 140 is composed of copper. In another implementation, the wire 140 is composed of any known elongated and flexible material. The wire 140 has ends 146, 148, with the upper portion 130, 132 of each arcuate member 126, 128, respectively, being secured to the ends 146, 148 of the wire 140 by fastening mechanisms 152, 154, respectively. In one implementation, as shown in FIG. 1, each fastening mechanism 152, 154 is a narrow channel of a hollow upper portion 130, 132 of each arcuate member 126, 128, respectively. Each of the ends 146, 148 of the wire 140 engages the narrow channel of each hollow upper portion 130, 132 in a force fit. In another implementation, each fastening mechanism 152, 154 includes a clamp or other known grasping mechanisms configured to mechanically couple and secure the ends 146, 148 of the wire 140, respectively, to the upper portions 130, 132 of the arcuate members 126, 128, respectively. In another implementation, each arcuate member 126, 128 includes an internal slot to guide the wire 140 between coupling points in the body 106. For example, the positioning of the wire 140 within the slots of the arcuate members 126, 128 ensures that a pulling force applied by an actuator of the platform 104, as described below, and translated by the wire 140 is normal to each respective first and second assemblies, respectively, as first and second wheel rotation anchors, respectively.

In one implementation, the platform 104 includes a housing having an interior to retain electronics. For example, the platform 104 is a component of an unmanned robot, such as an unmanned aircraft vehicle (UAV), such as a drone or other known robotic devices, including a crawler, a roller, a walker, an autonomous underwater vehicle (AUV), etc., such as described in U.S. Pat. No. 11,235,823, incorporated above. In another example, the platform 104 is a component of a stationary docking system or a discrete moving vehicle.

Referring to FIG. 1, in one implementation consistent with the invention, the platform 104 includes an actuator 160 having a base and telescopic member or arm configured to extend from or retract into the base. The platform 104 also includes a fastener 170 disposed at an end of the telescopic member and configured to removably engage and mechanically couple with the wire 140. For example, as shown in FIG. 1, the fastener 170 is an upwardly curved hook configured to mechanically and removably couple the wire 140 to a lower portion of the actuator 160. As gravity pulls the wire 140 downward onto an upwardly oriented surface of the hook, the wire 140 is mechanically and removably coupled to the upwardly curved hook. In another example, the fastener 170 is a downward L-shaped hook with a horizontal portion of the L-shaped hook configured to mechanically and removably couple the wire 140 to the lower portion of the actuator 160. As gravity pulls the wire 140 downward onto an upwardly oriented surface of the horizontal portion of the L-shaped hook, the wire 140 is mechanically and removably coupled to the L-shaped hook. In a further example, the fastener 170 is a clamp or other known grasping mechanisms configured to mechanically and removably couple and secure the wire 140 to the lower portion of the actuator 160. In another implementation, the wire 140 and the fastener 170 are magnetic with opposite polarities to attract each other by magnetic attraction, allowing the wire 140 and the fastener 170 to be magnetically coupled when in proximity to each other. In a further implementation, one of the wire 140 and the fastener 170 is a permanent magnet, and the other of the wire 140 and the fastener 170 is magnetically attracted to the permanent magnet. In an alternative implementation, one of the wire 140 and the fastener 170 is an electromagnet controlled by electronics in the crawler 102 or the platform 104, respectively, and the other of the wire 140 and the fastener 170 is magnetically attracted to the electromagnet magnet. Such magnetic attraction of the wire 140 and the fastener 170 to be magnetically and removably coupled enhances the mechanical and removable coupling of the wire 140 with the fastener 170.

In an implementation, the actuator 160 is a linear actuator configured to extend or retract the telescoping member or arm in a linear direction in response to control signals from electronics included in the platform 104. In another implementation, the actuator 160 is any known actuator configured to move components of the crawler 102 toward or away from components of the platform 104. In a further implementation, the actuator 160 includes motors such as servomotors configured to extend or retract a component such as the crawler 102 in any selected direction. The actuator 160 applies sufficient force to the wire 140 to convey a torque required to rotate and tilt the magnetic wheels 114, 116 about the pivot points 122, 124.

In an alternative implementation, the actuator 160 shifts the fastener 170 in sideways directions in addition to vertical linear movement, which enables the actuator 160 to provide more torque on one side initially. Such sideways movement of the fastener 170 is translated to the wire 140, allowing the wheels 114, 116 to disengage from the surface 200 one by one. Accordingly, the actuator 160 does not need to overcome the magnetic forces of the wheels 114, 116 at the same time. In another implementation, such sideways movement of the fastener 170 allows for a selection of an actuator 160 rated with less pulling force to perform the pulling and disengagement of the wheels 114, 116 from the surface 200.

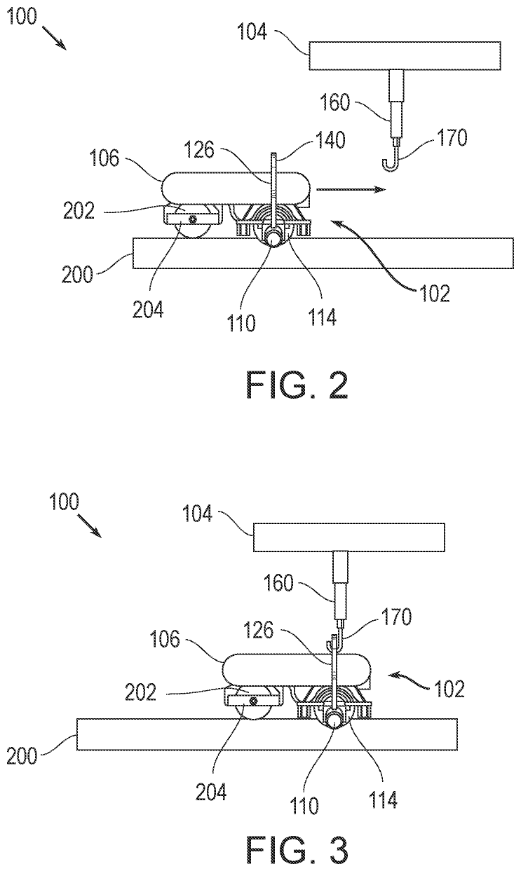

FIGS. 2-7 illustrate the process of detaching the crawler 102 from the surface 200 of the structure. As described above, the surface 200 includes a ferromagnetic composition, such as iron.

In another implementation, the surface 200 includes any known materials configured to be magnetically attracted and coupled to the magnetic wheels 114, 116. As shown in a side view of the apparatus 100 in FIG. 2, the crawler 102 approaches the platform 104, for example, from the left, as shown by the rightward arrow, with the crawler 102 magnetically coupled to the surface 200 of a structure by the magnetic wheels 114, 116. In one implementation, the crawler 102 also includes a drive wheel 202 rotatably mounted to a frame 204 attached to the body 106 of the crawler 102. Rotation of the drive wheel 202 clockwise or counterclockwise determines the direction parallel to the surface 200 in which the crawler 102 moves on the surface 200.

In one implementation, as the magnetic wheels 114, 116 are magnetically coupled to and moving along the surface 200, a contacting portion of each magnetic wheel 114, 116 is flush with the surface 200 due to the magnetic attraction between each of the magnetic wheels 114, 116 and the surface 200. For example, a portion of the surface 200 at the contact point of at least one magnetic wheel 114, 116 is planar. In another example, the portion of the surface 200 at the contact point of at least one magnetic wheel 114, 116 is curved. In a further example, one magnetic wheel 114 is magnetically coupled to a planar portion of the surface 200, while the other magnetic wheel 116 is magnetically coupled to a curved portion of the surface 200.

As shown in the side view of the apparatus 100 in FIG. 3, the crawler 102 is positioned under the platform 104 such that the wire 140 moves to a position vertically above a lower portion of the fastener 170. In one implementation, a control system of the platform 104 is configured to control the actuator 160 to adjust and establish a height level for the lower portion of the fastener 170 to match an elevation of the wire 140. For example, the height level is not to be so low to allow the fastener 170 to contact or hit the body 106. Once the heights and elevations of components are matched, the mechanical or magnetic coupling of components of the crawler 102 and the platform 104 is established.

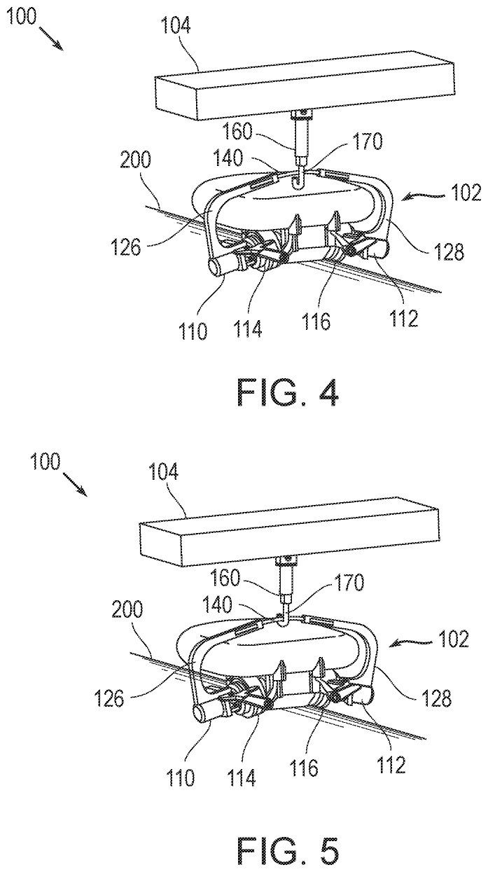

FIG. 4 illustrates a top front side perspective view of the apparatus 100 in FIG. 3, with the crawler 102 positioned under the platform 104 and with a lower surface of the wire 140 positioned above an upper surface of the fastener 170. The platform 104 directs the actuator 160 to retract the telescoping member or arm, as shown in the upward arrows in FIG. 5, until the upwardly oriented portion of the fastener 170 engages the wire 140. The fastener 170 then begins pulling the wire 140 upward towards the platform 104. In one implementation, the wire 140 and the fastener 170 are coupled by the action of gravity with the wire 140 pulled downwards by gravity onto the fastener 170. In another implementation, the wire 140 and the fastener 170 are coupled by a friction fit. In a further implementation, the fastener 170 includes a clamp or other known grasping mechanisms configured to mechanically and removably couple the wire 140 to the fastener 170.

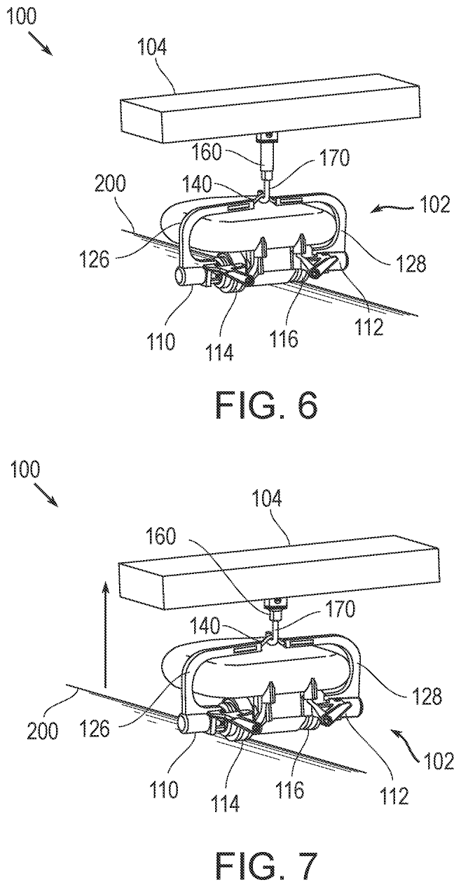

As shown in FIG. 6, further retraction of the telescopic member of the actuator 160 moves the fastener 170 further upward to pull a middle portion of the wire 140 further upward. Such further pulling of the middle portion of the wire 140 in turn pulls the ends 146, 148 of the wire 140 to move in at least a horizontal direction. At least horizontal movement of the ends 146, 148 of the wire 140 in turn pulls the upper portions 130, 132 of the arcuate members 126, 128, respectively, to move at least horizontally. Such horizontal movement of the upper portions 130, 132 lifts the outward ends of the side members 110, 112, respectively, such that the side members 110, 112, the arms 118, 120, and the magnetic wheels 114, 116 rotate about the pivot points 122, 124, respectively.

In an implementation shown in FIGS. 1-7, the magnetic wheel 114 rotates in a clockwise direction about the pivot point 122, while the magnetic wheel 116 rotates in a counterclockwise direction about the pivot point 124. Such rotation of the magnetic wheels 114, 116 causes an outer portion of each wheel 114, 116 directed away from the center of the crawler 102 to move away from the surface 200. In an alternative implementation, the magnetic wheel 114 rotates in a first direction about the pivot point 122, while the magnetic wheel 116 rotates in a second direction about the pivot point 124. For example, the first and second directions of rotation are opposite angular directions. In another example, the first and second directions of rotation are in the same angular direction. In a further implementation, only one of the magnetic wheels 114, 116 is rotated to have a portion of the rotated magnetic wheel 114, 116 move away from the surface 200.

Any rotation of the magnetic wheels 114, 116 about the pivot points 122, 124, respectively, causes a portion of the rotated magnetic wheels 114, 116 to move away from the surface 200. In one implementation, as shown in FIG. 5, an outer portion of each wheel 114, 116 directed away from the center of the crawler 102 moves away from the surface 200. Since the strength of magnetic attraction between the magnetic wheels 114, 116 and the surface 200 is inversely proportional to at least the distance between the magnetic wheels 114, 116 and the surface 200, the rotation of the wheels 114, 116 about the pivot points 122, 124, respectively, causes a reduction in the magnetic coupling or adhesion of the wheels 114, 116 with the surface 200. FIG. 6 illustrates the rotation of the side members 110, 112, the arms 118, 120, and the magnetic wheels 114, 116 about the pivot points 122, 124, respectively, from the configuration of such side members 110, 112, the arms 118, 120, and the magnetic wheels 114, 116 shown in FIG. 5. Accordingly, the configuration of the crawler 102 with rotated magnetic wheels 114, 116, as shown in FIG. 6, has a reduced magnetic coupling or adhesion of the crawler 102 to the surface 200, which facilitates removal of the crawler 102 from the surface 200.

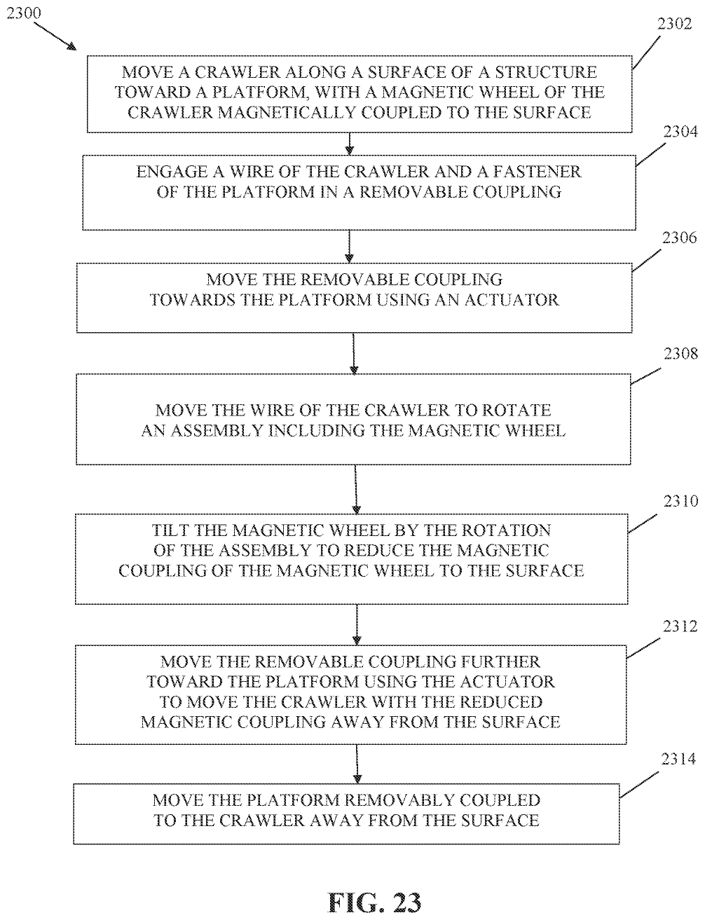

With the crawler 102 in such a configuration in FIG. 6, the actuator 160 lifts upward the fastener 170 mechanically and removably coupled to the wire 140, as shown by the upward arrow in FIG. 6, to further weaken the magnetic coupling or adhesion of the wheels 114, 116 and the surface 200. Since the rotated magnetic wheels 114, 116 have a reduced magnetic coupling or adhesion with the surface 200, the entire crawler 102 is readily detached from and lifted away from the surface 200 by the platform 104, as shown in FIG. 7. In an implementation, the apparatus 100 with at least the platform 104 is a UAV, allowing the apparatus 100 with the crawler 102, detached from the surface 200, to fly away from the surface 200. The steps illustrated in FIGS. 2-7 and as described above are further described below in conjunction with the method 2300 having the steps of the flowchart illustrated in FIG. 23.

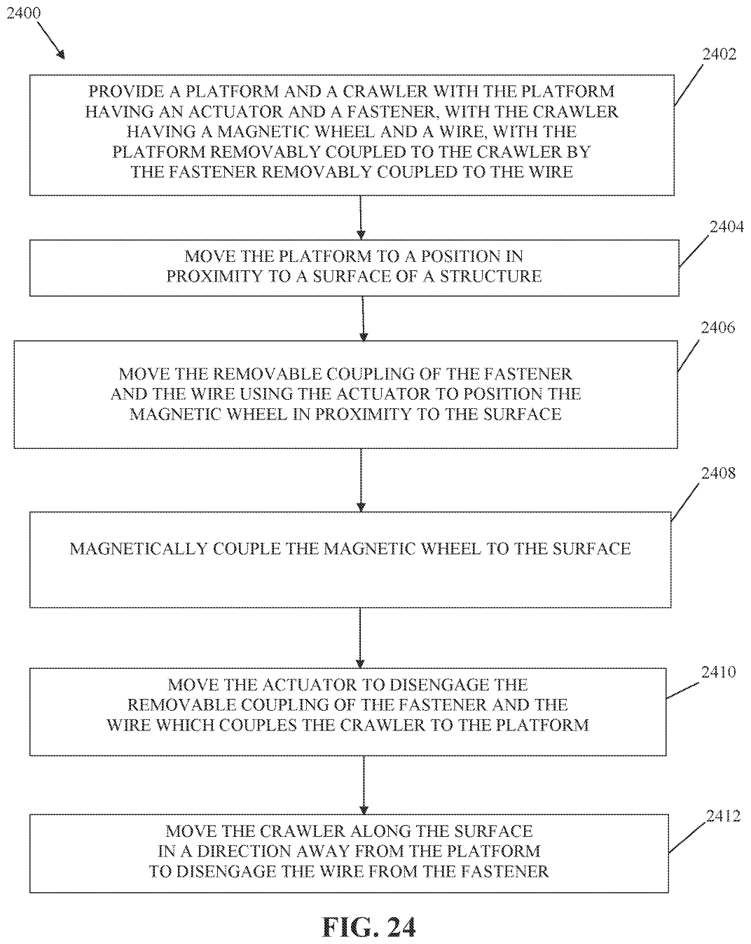

It is to be understood that the steps of detaching the crawler 102 from the surface 200 and attaching the crawler 102 to the platform 104 shown in FIGS. 2-7 are reversible to attach the crawler 102 to the surface 200 and to detach the crawler 102 from the platform 104. That is, the illustrated steps described above, proceeding from the configuration of the apparatus 100 and the surface 200 in FIG. 7 to the configuration of the apparatus 100 and the surface 200 in FIG. 2 are performed to attach the crawler 102 to the surface 200 and to detach the crawler 102 to the platform 104. The reverse progression of the steps illustrated in FIGS. 2-7 and as described above are further described below in conjunction with the method 2400 having the steps of the flowchart illustrated in FIG. 24.

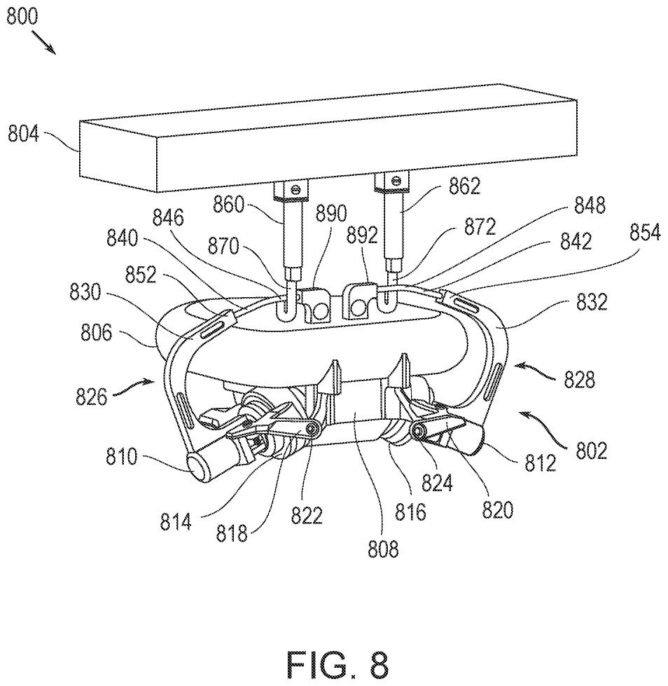

In an alternative implementation shown in FIGS. 8-14, consistent with the invention, the apparatus 800 includes a crawler 802 and a platform 804. The crawler 802 includes a chassis or body 806 and a sub-assembly 808. In one implementation, the sub-assembly 808 includes a probe configured to inspect the surface along which the crawler 802 moves. For example, the probe in the sub-assembly 808 is an ultrasound emitter and detector. In another example, the probe is an electromagnetic emitter and detector, such as camera with a light. The probe is configured to inspect the physical surface of the structure or to inspect the structure itself, for example, for cracks, rust, or other corrosion. In another implementation, the sub-assembly 808 includes any known payload included in or coupled to the crawler 802.

Referring to FIG. 8, the body 806 includes a housing having an interior to retain electronics. In one implementation, the crawler 802 includes a robot, a walker, or other known vehicles, such as described in U.S. Pat. No. 11,235,823, incorporated above. In addition, the body 806 also includes a pair of side members 810, 812, with each side member 810, 812 rotatably coupled to an axle of a wheel 814, 816, respectively. Each wheel 814, 816 is configured to rotate about a respective axle. Each side member 810, 812 is attached to an arm 818, 820, respectively. In one implementation, the crawler 802 includes at least one wheel. In another implementation, the crawler 802 includes a pair of wheels 814, 816 disposed on opposite portions of the crawler 802, such as opposite sides of the crawler 802 as shown in FIG. 8. In a further implementation, the crawler 802 includes four wheels. In an implementation consistent with the invention, the wheels 814, 816 are composed of a magnetic material. In one implementation, at least the outer surfaces of the wheels 814, 816 are composed of magnetic material. For example, the wheels 814, 816 are permanent magnets. In another example, the wheels 814, 816 are electromagnets, with at least an electronic switch and a power source disposed in the body 806 to activate and deactivate the magnetism of each wheel 814, 816. In such examples, the magnetic wheels 814, 816 are configured to be magnetically attracted to magnetic structures. As described below, the crawler 802 with the magnetic wheels 814, 816 is configured to move along a surface of a structure. In one implementation, the surface includes a ferromagnetic composition, such as iron. In another implementation, the surface includes any known materials configured to be magnetically attracted and coupled to the magnetic wheels 814, 816. Such magnetic attraction between a surface and the wheels 814, 816 of the crawler 802 allows the crawler 802 to be removably held against the surface and to move adjacent to the surface, including curved surfaces, tilted surfaces, vertical surfaces, etc. without detaching.

A first assembly of the side member 810, the magnetic wheel 814, and the arm 818 is pivotally attached to the body 806 by a pivot point 822 as a first wheel rotation anchor. Similarly, a second assembly of the side member 812, the magnetic wheel 816, and the arm 820 is pivotally attached to the body 806 by a pivot point 824 as a second wheel rotation anchor. Accordingly, the first and second assemblies pivot about the pivot points 822, 824, respectively, which tilts the magnetic wheels 814, 816 and reduces the magnetic coupling or adhesion of the magnetic wheels 814, 816 to the surface 900.

In one implementation, each side member 810, 812 includes an arcuate member 826, 828, respectively, with the arcuate members 826, 828 curving around a side of the body 806 and over a top portion of the body 806. The arcuate members 826, 828 have upper portions 830, 832 extending over the top portion of the body 806. A pair of wires 840, 842 extend over the top of the body 806, with the wire 840 associated with the arcuate member 826, and the wire 842 associated with the arcuate member 826. For example, each of the wires 840, 842 is a cable or other elongated and flexible material having a relatively strong tensile strength. In one implementation, each of the wires 840, 842 is composed of copper. In another implementation, each of the wires 840, 842 is composed of any known elongated and flexible material.

Each of the wires 840, 842 has an outer end 846, 848, respectively, oriented away from a central portion of the body 806. Each of the wires 840, 842 also has an inner end 886, 888, respectively, oriented toward the central portion of the body 806. The upper portion 830, 832 of each arcuate member 826, 828, respectively, is secured to the outer ends 846, 848, respectively, of the wires 840, 842, respectively, by fastening mechanisms 852, 854, respectively. In one implementation, as shown in FIG. 8, each fastening mechanism 852, 854 is a narrow channel of a hollow upper portion 830, 832 of each arcuate member 826, 828, respectively. Each of the outer ends 846, 848 of the wires 840, 842, respectively, engages the narrow channel of each hollow upper portion 830, 832 in a force fit. In another implementation, each fastening mechanism 852, 854 includes a clamp or other known grasping mechanisms configured to mechanically couple and secure the outer ends 846, 848 of the wires 840, 842, respectively, to the upper portions 830, 832 of the arcuate members 826, 828, respectively.

In one implementation, each of the inner ends 886, 888 of the wires 840, 824, respectively, is attached to a mounting member 890, 892, respectively. The mounting members 890, 892 are in turn attached to a top surface of the body 806. For example, the mounting members 890, 892 are secured to the top surface of the body 806 by adhesive, welding, or other known fastening methods. In another example, the mounting members 890, 892 are monolithically integrated with the top surface of the body 806, such as being formed during fabrication of the body 806 by plastic extrusion or other known fabrication methods. In another implementation, each of the inner ends 886, 888 of the wires 840, 824, respectively, is pivotally attached to the mounting member 890, 892, respectively. For example, such pivotally attaching of the inner ends 886, 888 of the wires 840, 824, respectively, to the mounting members 890, 892, respectively, allow the wires 840, 842 to pivot in a vertical direction, as described below.

In one implementation, the platform 804 includes a housing having an interior to retain electronics. For example, the platform 804 is a component of an unmanned robot, such as an unmanned aircraft vehicle (UAV), such as a drone or other known robotic devices, including a crawler, a roller, a walker, an autonomous underwater vehicle (AUV), etc., such as described in U.S. Pat. No. 11,235,823, incorporated above. In another example, the platform 804 is a component of a stationary docking system or a discrete moving vehicle.

Referring to FIG. 8, in one implementation consistent with the invention, the platform 804 includes a pair of actuators 860, 862, with each actuator 860, 862 having a base and telescopic member or arm configured to extend from or retract into the base. The platform 104 also includes fasteners 870, 872 disposed at an end of the telescopic member and configured to removably engage and mechanically couple with a respective wire 840, 842. For example, as shown in FIG. 8, the fasteners 870, 872 are upwardly curved hook configured to mechanically and removably couple a respective wire 840, 842 to a lower portion of the actuators 860, 862. As gravity pulls the wires 840, 842 downward onto an upwardly oriented surface of the respective hook, the wires 840, 842 are mechanically and removably coupled to the respective upwardly curved hook. In another example, the fasteners 870, 872 are downward L-shaped hooks, each having a horizontal portion of the L-shaped hook configured to mechanically and removably couple the respective wires 840, 842 to the lower portion of the actuators 860, 862, respectively. As gravity pulls the wire 840, 842 downward onto an upwardly oriented surface of the horizontal portions of the L-shaped hooks, respectively, the wires 840, 842 are mechanically and removably coupled to the respective L-shaped hooks. In a further example, the fasteners 870, 872 are clamps or other known grasping mechanisms configured to mechanically and removably couple and secure the wires 840, 840, respectively, to the lower portion of each actuator 860, 862. In another implementation, the wires 840, 842 and the fasteners 870, 872 are magnetic with opposite polarities to attract each other by magnetic attraction, allowing the wires 840, 842 and the fasteners 870, 872 to be magnetically coupled when in proximity to each other. In a further implementation, one of the wires 840, 842 and the fasteners 870, 872 are permanent magnets, and the other of the wires 840, 842 and the fastener 870, 872 are magnetically attracted to the permanent magnet. In an alternative implementation, one of the wires 840, 842 and the fasteners 870, 872 is an electromagnet controlled by electronics in the crawler 802 or the platform 804, respectively, and the other of the wires 840, 842 and the fasteners 870, 872 is magnetically attracted to the electromagnet magnet. Such magnetic attraction of the wires 840, 842 and the fasteners 870, 872 to be magnetically and removably coupled enhances the mechanical and removable coupling of the wires 840, 842 with the respective fasteners 870, 872.

In an implementation, the actuators 860, 862 are linear actuators configured to extend or retract a telescoping member or arm in a linear direction in response to control signals from electronics included in the platform 804. In another implementation, the actuators 860, 862 are any known actuators configured to move components of the crawler 802 toward or away from components of the platform 804. In a further implementation, the actuators 860, 862 includes motors such as servomotors configured to extend or retract a component such as the crawler 802 in any selected direction. The actuators 860, 862 apply sufficient force to the wires 840, 842 to convey torques required to rotate and tilt the magnetic wheels 814, 816 about the pivot points 822, 824.

In an alternative implementation, the actuators 860, 862 shift the fasteners 870, 872 in sideways directions in addition to vertical linear movement, which enables the actuators 860, 862 to provide more torque on one side initially. Such sideways movement of the fasteners 870, 872 is translated to the wires 840, 842, allowing the wheels 814, 816 to disengage from the surface 900 one by one. Accordingly, the actuators 860, 862 does not need to overcome the magnetic forces of the wheels 814, 816 at the same time. In another implementation, such sideways movement of the fasteners 870, 872 allows for a selection of actuators 860, 862 rated with less pulling force to perform the pulling and disengagement of the wheels 814, 816 from the surface 900.

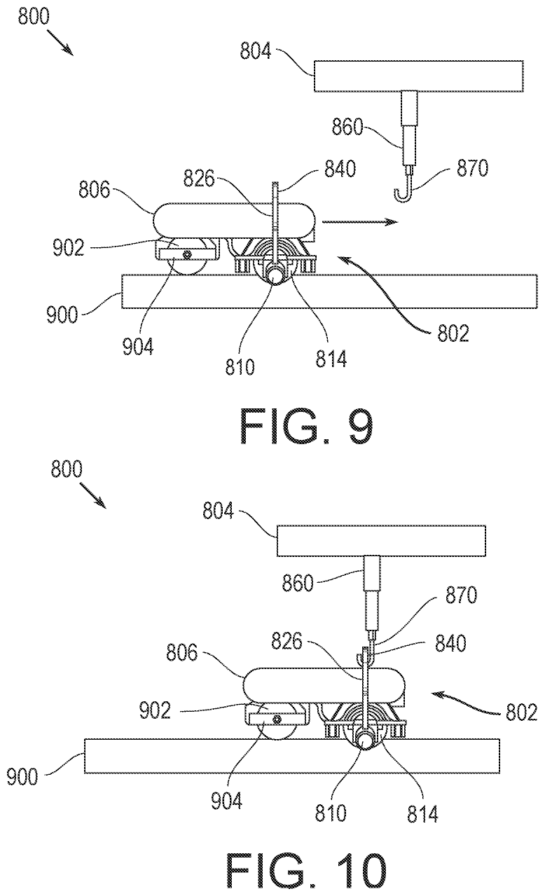

FIGS. 9-14 illustrate the process of detaching the crawler 802 from the surface 900 of the structure. As described above, the surface 900 includes a ferromagnetic composition, such as iron. In another implementation, the surface 900 includes any known materials configured to be magnetically attracted and coupled to the magnetic wheels 814, 816. As shown in a side elevational view of the apparatus 800 in FIG. 9, the crawler 802 approaches the platform 804, for example, from the left, as shown by the rightward arrow, with the crawler 802 magnetically coupled to the surface 900 of a structure by the magnetic wheels 814, 816. In one implementation, the crawler 802 also includes a drive wheel 902 rotatably mounted to a frame 904 attached to the body 806 of the crawler 802. Rotation of the drive wheel 902 clockwise or counterclockwise determines the direction parallel to the surface 900 in which the crawler 802 moves on the surface 900.

In one implementation, as the magnetic wheels 814, 816 are magnetically coupled to and moving along the surface 900, a contacting portion of each magnetic wheel 814, 816 is flush with the surface 900 due to the magnetic attraction between each of the magnetic wheels 814, 816 and the surface 900. For example, a portion of the surface 900 at the contact point of at least one magnetic wheel 814, 816 is planar. In another example, the portion of the surface 900 at the contact point of at least one magnetic wheel 814, 816 is curved. In a further example, one magnetic wheel 814 is magnetically coupled to a planar portion of the surface 900, while the other magnetic wheel 816 is magnetically coupled to a curved portion of the surface 900.

As shown in the side elevational view of the apparatus 800 in FIG. 10, the crawler 802 is positioned under the platform 804 such that the wires 840, 842 move to a position vertically above a lower portion of the fasteners 870, 872, respectively. In one implementation, a control system of the platform 804 is configured to control the actuators 860, 862 to adjust and establish height levels for the lower portion of the fasteners 870, 872, respectively, to match an elevation of the wires 840, 842. For example, the height levels are not to be so low to allow the fastener 870, 872 to contact or hit the body 806. Once the heights and elevations of components are matched, the mechanical or magnetic coupling of components of the crawler 802 and the platform 804 is established.

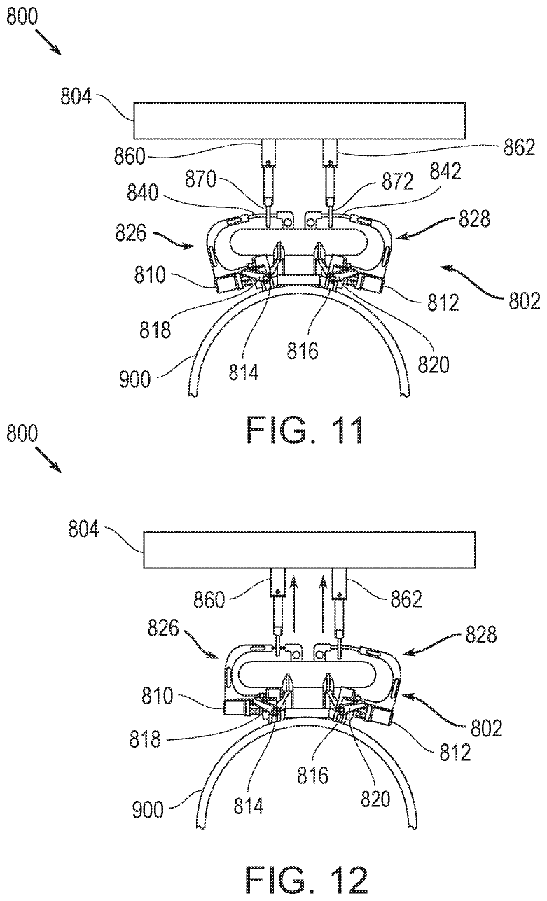

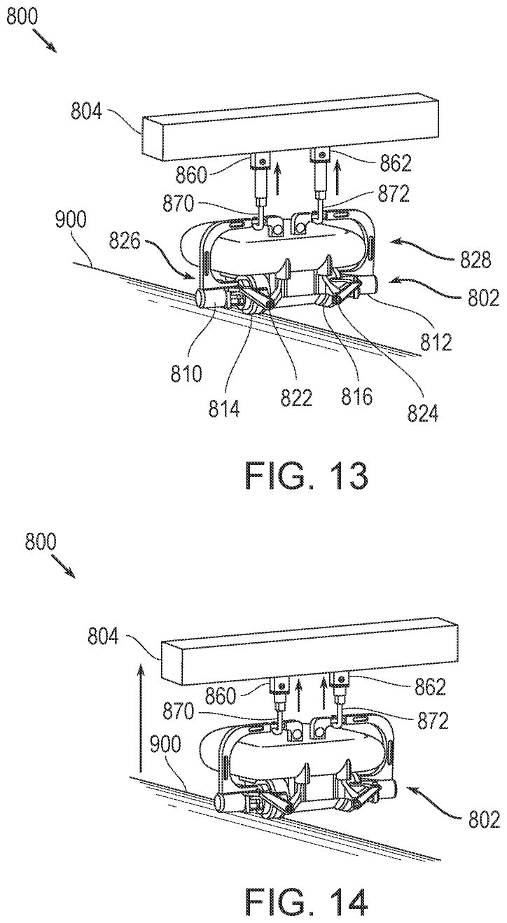

FIG. 11 illustrates a front elevational view of the apparatus 800 in FIG. 10, with the crawler 802 positioned under the platform 804 and with a lower surface of the wires 840, 842 positioned above an upper surface of the fasteners 870, 872, respectively. In one implementation, the platform 804 emits control signals to the actuator 860 to retract the telescoping member or arm, as shown in the upward arrow in FIG. 11, until the upwardly oriented portion of the fastener 870 engages the wire 840. The fastener 870 pulls the wire 840 upward towards the platform 804, and so the fastener 870 engages and pulls the corresponding wire 840 to rotate the arcuate member 826. In turn, the side member 810 and the magnetic wheel 814 are rotated about the pivot point 822, which tilts the magnetic wheel 814 and reduces the magnetic coupling or adhesion of the magnetic wheel 814 to the surface 900. As further shown in FIG. 12, the actuator 862 has not completed the retraction of the fastener 872, and so the fastener 872 has not engaged and pulled the corresponding wire 842 to rotate the arcuate member 828. Accordingly, the side member 812 and the magnetic wheel 816 have not been rotated about the pivot point 824, and so the magnetic wheel 816 remains magnetic coupled or adhering to the surface 900. Once the platform 804 controls the actuator 860 to cause the magnetic wheel 814 to tilt and have a reduced magnetic coupling or adhesion of the magnetic wheel 814 to the surface 900, as shown in FIG. 12, the platform 804 emits control signals to the actuator 862 to retract the telescoping member, as shown in the upward arrow in FIG. 12, until the upwardly oriented portion of the fastener 872 engages the wire 842. The fastener 872 pulls the wire 842 upward towards the platform 804, and so the fastener 872 engages and pulls the corresponding wire 842 to rotate the arcuate member 828. In turn, the side member 812 and the magnetic wheel 816 are rotated about the pivot point 824, which tilts the magnetic wheel 816 and reduces the magnetic coupling or adhesion of the magnetic wheel 816 to the surface 900. Accordingly, the apparatus 800 has the configuration shown in FIG. 13, with both magnetic wheels 814, 816 having a reduce magnetic coupling or adhesion of the magnetic wheel 816 to the surface 900.

In another implementation, the platform 804 emits control signals to the actuators 860, 862 at different times or at the same time but with different rates to retract the fasteners 870, 872, respectively, with different timing or different speeds to pull the wires 840, 842, respectively, in a non-uniform manner. Such different operations of the actuators 860, 862 is performed, for example, to selectively tilt the magnetic wheels 814, 186 one-by-one. Accordingly, as shown in FIG. 12, the configuration of the actuators 860, 862, the fasteners 870, 872, and the tilting of the magnetic wheels 814, 816 allows the apparatus 800 to selectively reduce the magnetic coupling or adhesion of the magnetic wheel 814, 816 with the surface 900 one at a time. Such selective tilting of the magnetic wheels 814, 816 at different times reduces the required amount of torque on the magnetic wheels 814, 816 to be removed from the surface 900 compared to simultaneously tilting both magnetic wheels 814, 816 at the same time.

In a further implementation, the platform 804 emits control signals to the actuators 860, 862 to simultaneously retract the fasteners 870, 872 with substantially the same speed, respectively, to pull the wires 840, 842, respectively, resulting in both magnetic wheels 814, 186 uniformly tilting and reducing the magnetic coupling or adhesion with the surface 900, as shown in FIG. 13.

In one implementation, the wires 840, 842 and the fasteners 870, 872 are coupled by the action of gravity with the wires 840, 842 pulled downwards by gravity onto the fasteners 870, 872, respectively. In another implementation, the wires 840, 842 and the fasteners 870, 872 are coupled by a friction fit. In a further implementation, each of the fasteners 870, 872 includes a clamp or other known grasping mechanisms configured to mechanically and removably couple the wires 840, 842 to the fasteners 870, 872, respectively.

As shown in FIG. 13, upon retraction of the telescopic members of the actuators 860, 862, the fasteners 870, 872, respectively, move further upward to pull a middle portion of each of the wires 840, 842 further upward. Such further pulling of the middle portions of the wires 840, 842 in turn pulls the outer ends 846, 848 of the wires 840, 842, respectively, to move in at least a horizontal direction. At least horizontal movement of the outer ends 846, 848 of the wires 840, 842, respectively, in turn pulls the upper portions 830, 832 of the arcuate members 826, 828, respectively, to move at least horizontally. Such horizontal movement of the upper portions 830, 832 lifts the outward ends of the side members 810, 812, respectively, such that the side members 810, 812, the arms 818, 820, and the magnetic wheels 814, 816 rotate about the pivot points 822, 824, respectively.

In an implementation shown in FIGS. 8-14, the magnetic wheel 814 rotates in a clockwise direction about the pivot point 822, while the magnetic wheel 816 rotates in a counterclockwise direction about the pivot point 824. Such rotation of the magnetic wheels 814, 816 causes an outer portion of each wheel 814, 816 directed away from the center of the crawler 802 to move away from the surface 900. In an alternative implementation, the magnetic wheel 814 rotates in a first direction about the pivot point 822, while the magnetic wheel 816 rotates in a second direction about the pivot point 824. For example, the first and second directions of rotation are opposite angular directions. In another example, the first and second directions of rotation are in the same angular direction. In a further implementation, only one of the magnetic wheels 814, 816 is rotated to have a portion of the rotated magnetic wheel 814, 816 move away from the surface 900.

Any rotation of the magnetic wheels 814, 816 about the pivot points 822, 824, respectively, causes a portion of the rotated magnetic wheels 814, 816 to move away from the surface 000. In one implementation, as shown in FIG. 13, an outer portion of each wheel 814, 816 directed away from the center of the crawler 802 moves away from the surface 900. Since the strength of magnetic attraction between the magnetic wheels 814, 816 and the surface 900 is inversely proportional to at least the distance between the magnetic wheels 814, 816 and the surface 900, the rotation of the wheels 814, 816 about the pivot points 822, 824, respectively, causes a reduction in the magnetic coupling or adhesion of the wheels 814, 816 with the surface 900. FIG. 13 illustrates the completion of rotation of the side members 810, 812, the arms 818, 820, and the magnetic wheels 814, 816 about the pivot points 822, 824, respectively, from the configuration of such side members 810, 812, the arms 818, 820, and the magnetic wheels 814, 816 shown in FIGS. 11-12. Accordingly, the configuration of the crawler 802 with rotated magnetic wheels 814, 816, as shown in FIG. 13, has a reduced magnetic coupling or adhesion of the crawler 802 to the surface 900, which facilitates removal of the crawler 802 from the surface 900.

With the crawler 802 in such a configuration in FIG. 12, each of the actuators 860 further retracts to lift the fasteners 870, 872, respectively, further upward, which are mechanically and removably coupled to the wires 840, 842, respectively, as shown by the upward arrow in FIG. 13, to further weaken the magnetic coupling or adhesion of the wheels 814, 816 and the surface 900. Since the rotated magnetic wheels 814, 816 have a reduced magnetic coupling or adhesion with the surface 900, the entire crawler 802 is readily detached from and lifted away from the surface 900 by the platform 804, as shown in FIG. 14. In an implementation, the apparatus 800 with at least the platform 804 is a UAV, allowing the apparatus 800 with the crawler 802, detached from the surface 900, to fly away from the surface 900. The steps illustrated in FIGS. 9-14 and as described above are further described below in conjunction with the method 2300 having the steps of the flowchart illustrated in FIG. 23.

It is to be understood that the steps of detaching the crawler 802 from the surface 900 and attaching the crawler 802 to the platform 804 shown in FIGS. 9-14 are reversible to attach the crawler 802 to the surface 900 and to detach the crawler 802 from the platform 804. That is, the illustrated steps described above, proceeding from the configuration of the apparatus 800 and the surface 900 in FIG. 14 to the configuration of the apparatus 800 and the surface 900 in FIG. 9 are performed to attach the crawler 802 to the surface 900 and to detach the crawler 802 to the platform 804. The reverse progression of the steps illustrated in FIGS. 9-14 and as described above are further described below in conjunction with the method 2400 having the steps of the flowchart illustrated in FIG. 24.

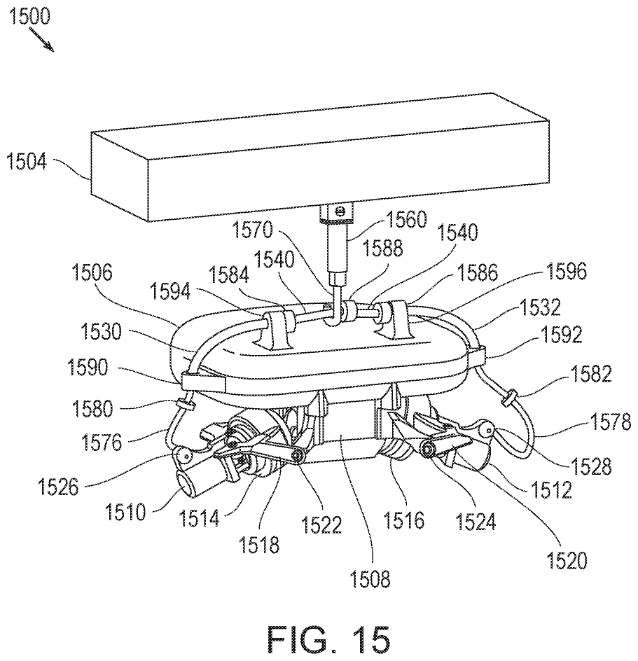

In another alternative implementation shown in FIGS. 15-22, consistent with the invention, an apparatus 1500 includes a crawler 1502 and a platform 1504. The crawler 1502 includes a chassis or body 1506 and a sub-assembly 1508. In one implementation, the sub-assembly 1508 includes a probe configured to inspect the surface along which the crawler 1502 moves. For example, the probe in the sub-assembly 1508 is an ultrasound emitter and detector. In another example, the probe is an electromagnetic emitter and detector, such as camera with a light. The probe is configured to inspect the physical surface of the structure or to inspect the structure itself, for example, for cracks, rust, or other corrosion. In another implementation, the sub-assembly 1508 includes any known payload included in or coupled to the crawler 1502.

Referring to FIG. 15, the body 1506 includes a housing having an interior to retain electronics. In one implementation, the crawler 1502 includes a robot, a walker, or other known vehicles, such as described in U.S. Pat. No. 11,235,823, incorporated above. In addition, the body 1506 also includes a pair of side members 1510, 1512, with each side member 1510, 1512 rotatably coupled to an axle of a wheel 1514, 1516, respectively. Each wheel 1514, 1516 is configured to rotate about a respective axle. Each side member 1510, 1512 is attached to an arm 1518, 1520, respectively. In one implementation, the crawler 1502 includes at least one wheel. In another implementation, the crawler 1502 includes a pair of wheels 1514, 1516 disposed on opposite portions of the crawler 1502, such as opposite sides of the crawler 1502 as shown in FIG. 15. In a further implementation, the crawler 1502 includes four wheels. In an implementation consistent with the invention, the wheels 1514, 1516 are composed of a magnetic material. In one implementation, at least the outer surfaces of the wheels 1514, 1516 are composed of magnetic material. For example, the wheels 1514, 1516 are permanent magnets. In another example, the wheels 1514, 1516 are electromagnets, with at least an electronic switch and a power source disposed in the body 1506 to activate and deactivate the magnetism of each wheel 1514, 1516. In such examples, the magnetic wheels 1514, 1516 are configured to be magnetically attracted to magnetic structures. As described below, the crawler 1502 with the magnetic wheels 1514, 1516 is configured to move along a surface of a structure. In one implementation, the surface includes a ferromagnetic composition, such as iron. In another implementation, the surface includes any known materials configured to be magnetically attracted and coupled to the magnetic wheels 1514, 1516. Such magnetic attraction between a surface and the wheels 1514, 1516 of the crawler 1502 allows the crawler 1502 to be removably held against the surface and to move adjacent to the surface, including curved surfaces, tilted surfaces, vertical surfaces, etc. without detaching.

A first assembly of the side member 1510, the magnetic wheel 1514, and the arm 1518 is pivotally attached to the body 1506 by a pivot point 1522 as a first wheel rotation anchor. Similarly, a second assembly of the side member 1512, the magnetic wheel 1516, and the arm 1520 is pivotally attached to the body 1506 by a pivot point 1524 as a second wheel rotation anchor. Accordingly, the first and second assemblies pivot about the pivot points 1522, 1524, respectively, which tilts the magnetic wheels 1514, 1516 and reduces the magnetic coupling or adhesion of the magnetic wheels 1514, 1516 to the surface 1600.

In one implementation, each side member 1510, 1512 includes a wire coupling point 1526, 1528, respectively, to which a wire 1540 is coupled. For example, the wire 1540 is a cable or other elongated and flexible material having a relatively strong tensile strength. In one implementation, the wire 1540 is composed of copper. In another implementation, the wire 1540 is composed of any known elongated and flexible material.

The wire 1540 curves around the sides of the body 1506 and over a top portion of the body 1506. Tubular wire guides 1530, 1532 extend around the sides of the body 1506 and over the top portion of the body 106, with the wire 1540 free to move along the interior of the tubular wire guides 1530, 1530. For example, an interior dimension across a cross-section of each tubular wire guide 1530, 1532 is greater than the maximum cross-section of the wire 1540. In one implementation, the tubular wire guides 1530, 1532 are cylindrical with a circular cross-section. In another implementation, the tubular wire guides 1530, 1532 are cylindrical with any known shape for a cross-section.

The ends of each of the tubular wire guides 1530, 1532 are secured to the body 1506 by mounting members 1590, 1592, 1594, 1596 attached to the body 1506. For example, the mounting members 1590, 1592, 1594, 1596 are secured to the side and top surface of the body 1506 by adhesive, welding, or other known fastening methods. In another example, the mounting members 1590, 1592, 1594, 1596 are monolithically integrated with the side and top surfaces of the body 1506, such as being formed during fabrication of the body 1506 by plastic extrusion or other known fabrication methods.

In an implementation, a plurality of stoppers 1580, 1582, 1584, 1586, 1588 are disposed around the exterior surface of the wire 1540 at selected locations. The stoppers 1580, 1582 are side wire stoppers disposed on the wire 1540 on the sides of the body 1506. The stoppers 1584, 1586 are top wires stoppers disposed on the wire 1540 on the top of the body 1506. The top wire stoppers 1584, 1586 are in contact with the body 1506 when the wire 1540 is not being pulled. The top wire stoppers 1584, 1586 allow a portion 1576 of the wire 1540 to be a strained wire side under tension on one side of the body 1506. In addition, the top wire stoppers 1584, 1586 allow a portion 1578 of the wire 1540 to be a loose wire side under less tension on the other side of the body 1506. As shown in FIG. 15, the portion 1576 of the wire 1540 is shorter than the portion 1578 of the wire 1540, which facilitates the portion 1576 to be strained relative to the portion 1578. As shown in FIG. 15, the side wire stopper 1580 is disposed on and surrounds the strained wire side 1576. In addition, the side wire stopper 1582 is disposed on and surrounds the loose wire side 1578. The stopper 1588 is a wire sliding stopper. As the wire 1540 is pulled, the loose wire side tends to slide along the fastener 1570 described below, instead of pulling the magnetic wheel 1516. The wire sliding stopper 1588 prevent the sliding of the wire 1540 as the wire 1540 presses against the fastener 1570.

In one implementation, the platform 1504 includes a housing having an interior to retain electronics. For example, the platform 1504 is a component of an unmanned robot, such as an unmanned aircraft vehicle (UAV), such as a drone or other known robotic devices, including a crawler, a roller, a walker, an autonomous underwater vehicle (AUV), etc., such as described in U.S. Pat. No. 11,235,823, incorporated above. In another example, the platform 1504 is a component of a stationary docking system or a discrete moving vehicle.

Referring to FIG. 15, in one implementation consistent with the invention, the platform 1504 includes an actuator 1560 having a base and telescopic member or arm configured to extend from or retract into the base. The platform 1504 also includes a fastener 1570 disposed at an end of the telescopic member and configured to removably engage and mechanically couple with the wire 1540. For example, as shown in FIG. 15, the fastener 1570 is an upwardly curved hook configured to mechanically and removably couple the wire 1540 to a lower portion of the actuator 1560. As gravity pulls the wire 1540 downward onto an upwardly oriented surface of the hook, the wire 1540 is mechanically and removably coupled to the upwardly curved hook. In another example, the fastener 1570 is a downward L-shaped hook with a horizontal portion of the L-shaped hook configured to mechanically and removably couple the wire 1540 to the lower portion of the actuator 1560. As gravity pulls the wire 1540 downward onto an upwardly oriented surface of the horizontal portion of the L-shaped hook, the wire 1540 is mechanically and removably coupled to the L-shaped hook. In a further example, the fastener 1570 is a clamp or other known grasping mechanisms configured to mechanically and removably couple and secure the wire 1540 to the lower portion of the actuator 1560. In another implementation, the wire 1540 and the fastener 1570 are magnetic with opposite polarities to attract each other by magnetic attraction, allowing the wire 1540 and the fastener 1570 to be magnetically coupled when in proximity to each other. In a further implementation, one of the wire 1540 and the fastener 1570 is a permanent magnet, and the other of the wire 1540 and the fastener 1570 is magnetically attracted to the permanent magnet. In an alternative implementation, one of the wire 1540 and the fastener 1570 is an electromagnet controlled by electronics in the crawler 1502 or the platform 1504, respectively, and the other of the wire 1540 and the fastener 1570 is magnetically attracted to the electromagnet magnet. Such magnetic attraction of the wire 1540 and the fastener 1570 to be magnetically and removably coupled enhances the mechanical and removable coupling of the wire 1540 with the fastener 1570.

In an implementation, the actuator 1560 is a linear actuator configured to extend or retract a telescoping member or arm in a linear direction in response to control signals from electronics included in the platform 1504. In another implementation, the actuator 1560 is any known actuator configured to move components of the crawler 1502 toward or away from components of the platform 1504. In a further implementation, the actuator 1560 includes motors such as servomotors configured to extend or retract a component such as the crawler 1502 in any selected direction. The actuator 1560 applies sufficient force to the wire 1540 to convey a torque required to rotate and tilt the magnetic wheels 1514, 1516 about the pivot points 1522, 1524.

In an alternative implementation, the actuator 1560 shifts the fastener 1570 in sideways directions in addition to vertical linear movement, which enables the actuator 1560 to provide more torque on one side initially. Such sideways movement of the fastener 1570 is translated to the wire 1540, allowing the wheels 1514, 1516 to disengage from the surface 1600 one by one. Accordingly, the actuator 1560 does not need to overcome the magnetic forces of the wheels 1514, 1516 at the same time. In another implementation, such sideways movement of the fastener 1570 allows for a selection of an actuator 1560 rated with less pulling force to perform the pulling and disengagement of the wheels 1514, 1516 from the surface 1600.

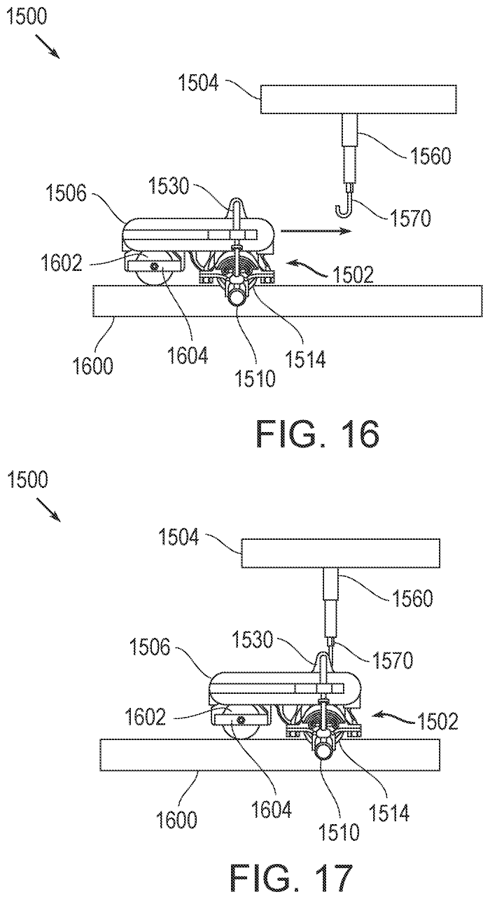

FIGS. 16-22 illustrate the process of detaching the crawler 1502 from the surface 1600 of the structure. As described above, the surface 1600 includes a ferromagnetic composition, such as iron. In another implementation, the surface 1600 includes any known materials configured to be magnetically attracted and coupled to the magnetic wheels 1514, 1516. As shown in a side view of the apparatus 1500 in FIG. 16, the crawler 1502 approaches the platform 1504, for example, from the left, as shown by the rightward arrow, with the crawler 1502 magnetically coupled to the surface 1600 of a structure by the magnetic wheels 15514, 116. In one implementation, the crawler 1502 also includes a drive wheel 1602 rotatably mounted to a frame 1604 attached to the body 1506 of the crawler 1502. Rotation of the drive wheel 1602 clockwise or counterclockwise determines the direction parallel to the surface 1600 in which the crawler 1502 moves on the surface 1600.

In one implementation, as the magnetic wheels 1514, 1516 are magnetically coupled to and moving along the surface 1600, a contacting portion of each magnetic wheel 1514, 1516 is flush with the surface 1600 due to the magnetic attraction between each of the magnetic wheels 1514, 1516 and the surface 1600. For example, a portion of the surface 1600 at the contact point of at least one magnetic wheel 1514, 1516 is planar. In another example, the portion of the surface 1600 at the contact point of at least one magnetic wheel 1514, 1516 is curved. In a further example, one magnetic wheel 1514 is magnetically coupled to a planar portion of the surface 1600, while the other magnetic wheel 1516 is magnetically coupled to a curved portion of the surface 1600.

As shown in the side view of the apparatus 1500 in FIG. 17, the crawler 1502 is positioned under the platform 1504 such that the wire 1540 moves to a position vertically above a lower portion of the fastener 1570. In one implementation, a control system of the platform 1504 is configured to control the actuator 1560 to adjust and establish a height level for the lower portion of the fastener 1570 to match an elevation of the wire 1540. For example, the height level is not to be so low to allow the fastener 1570 to contact or hit the body 1506. Once the heights and elevations of components are matched, the mechanical or magnetic coupling of components of the crawler 1502 and the platform 1504 is established.

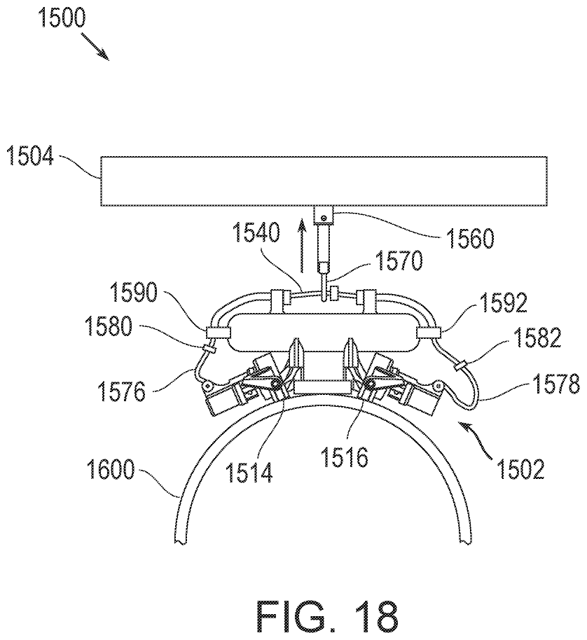

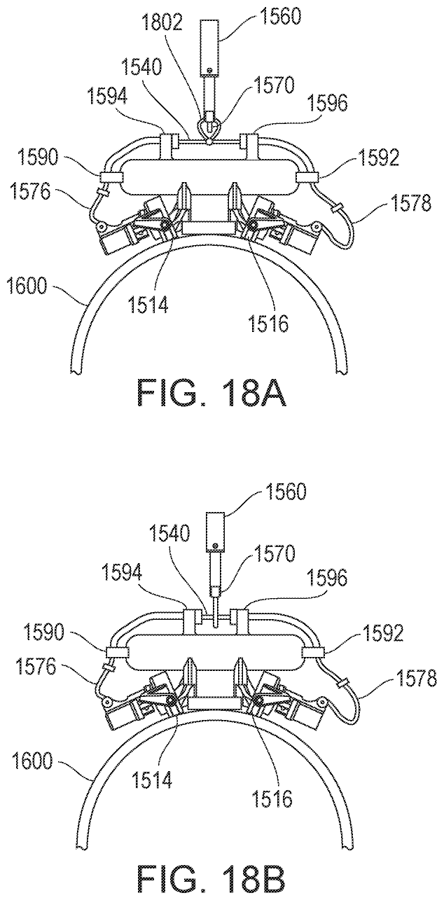

FIG. 18 illustrates a front elevational view of the apparatus 1500 in FIG. 17, with the crawler 1502 positioned under the platform 1504 and with a lower surface of the wire 1540 positioned above an upper surface of the fastener 1570. The platform 1504 emits control signals to the actuator 1560 to retract the telescoping member or arm, as shown in the upward arrow in FIG. 18, until the upwardly oriented portion of the fastener 1570 engages a middle portion of the wire 1540. The fastener 1570 then begins pulling the wire 1540 upward towards the platform 1504. In one implementation, the wire 1540 and the fastener 1570 are coupled by the action of gravity with the wire 1540 pulled downwards by gravity onto the fastener 1570. In another implementation, the wire 1540 and the fastener 1570 are coupled by a friction fit. In a further implementation, the fastener 1570 includes a clamp or other known grasping mechanisms configured to mechanically and removably couple the wire 1540 to the fastener 1570.

As the middle portion of the wire 1540 moves upward, the strained wire side 1576 moves upward through the tubular wire guide 1530 until the strained wire stopper 1580 hits a lower portion of the mounting member 1590, as shown in FIG. 19. The stoppage of the upward movement of the strained wire side 1576 cause the magnetic wheel 1514 to tilt, which reduces the magnetic coupling or adhesion of the magnetic wheel 1514 with the surface 1600. Then the magnetic wheel 1514 magnetically disengages from the surface 1600.

In one implementation, the locations of the stoppers 1580, 1582 and the length of the portions 1576, 1578 of the wire 1540, as shown in FIG. 18, are set or adjusted to be tuned such that the detachment of both wheels 1514, 1516 from the surface 1600 occurs before the stoppers 1580, 1582 hit the body 1506 or the mounting members 1590, 1592, allowing for proper retraction of the wheels 1514, 1516 from the surface 1600. In another implementation, the stoppers 1580, 1582 are completely removed from the apparatus 1500 without significantly affecting the operation of the mechanism.

In a further implementation shown in FIG. 18A, a small loop 1802 is added to the top wire 1540 through which the hook of the fastener 1570 attaches. Engaging the loop 1802 prevents side slippage of the hook of the fastener 1570 along the top wire 1540, aiding in the proper detachment of both of the top wire 1540 and the hook of the fastener 1570 sequentially. In an additional implementation, each of the portions 1576, 1578 of the wire 1540 on the left and right, respectively, of the apparatus 1500, shown in FIG. 18, are replaced with a respective loop of wire such that both left and right loops on either side of the apparatus 1500 are linked together on the top side of the apparatus 1500, and the hook of the fastener 1570 simply connects to the joint link to pull both loops up. As in the implementation shown in FIG. 15 and described above, in which the portion 1576 of the wire 1540 is shorter than the portion 1578 of the wire 1540, one loop is shorter than the other to allow for sequential wheel detachment of the wheels 1514, 1516.

In still another implementation shown in FIG. 18B, to improve ease of attachment of the hook of the fastener 1570 to the top side of the apparatus 1500, a top portion of the wire 1540 does not have a small hooking loop, but is just configured to be shorter to reduce the side slippage of the wire 1540 on the hook of the fastener 1570, while the top portion of the wire 1540 is being pulled up by the fastener 1570. The length of the top portion of the wire 1540 is smaller than the difference in length between the left and right sides of the wire 1540 which pull the two wheels 1514, 1516, respectively.

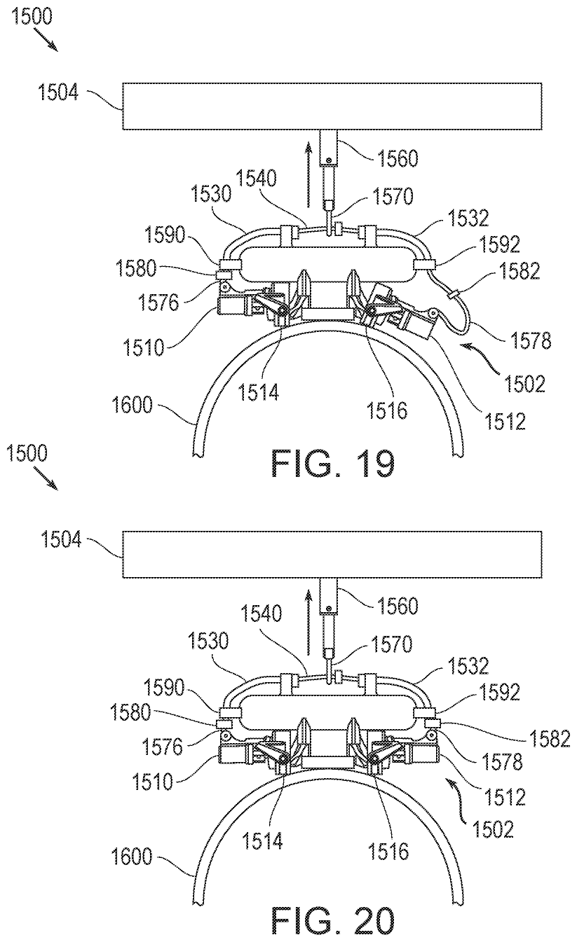

Referring back to the configuration of the apparatus 1500 in FIG. 18, after pulling a strained wire side 1576 of the wire 1540, the strained wire side 1576 is taut, and a portion of the magnetic wheel 1514 is tilted away from the surface 1600 as shown in FIG. 19, which reduces the magnetic coupling or adhesion of the magnetic wheel 1514 with the surface 1600. Further upward retraction of the telescoping member or arm of the actuator 1560 pulls the wire 1540 to then pull the loose wire side 1578 of the wire 1540. The loose wire side 1578 moves upward through the tubular wire guide 1532 until the loose wire stopper 1582 hits a lower portion of the mounting member 1592, as shown in FIG. 20. The loose wire side 1578 is then taut. The stoppage of the upward movement of the loose wire side 1578 cause the magnetic wheel 1516 to tilt, such that a portion of the magnetic wheel 1516 is tilted away from the surface 1600 as shown in FIG. 20, which reduces the magnetic coupling or adhesion of the magnetic wheel 1516 with the surface 1600. Then the magnetic wheel 1516 magnetically disengages from the surface 1600.

In an implementation shown in FIGS. 16-22, the magnetic wheel 1514 rotates in a clockwise direction about the pivot point 1522, while the magnetic wheel 1516 rotates in a counterclockwise direction about the pivot point 1524. Such rotation of the magnetic wheels 1514, 1516 causes an outer portion of each wheel 1514, 1516 directed away from the center of the crawler 1502 to move away from the surface 1600. In an alternative implementation, the magnetic wheel 1514 rotates in a first direction about the pivot point 1522, while the magnetic wheel 1516 rotates in a second direction about the pivot point 1524. For example, the first and second directions of rotation are opposite angular directions. In another example, the first and second directions of rotation are in the same angular direction. In a further implementation, only one of the magnetic wheels 1514, 1516 is rotated to have a portion of the rotated magnetic wheel 1514, 1516 move away from the surface 1600.

Any rotation of the magnetic wheels 1514, 1516 about the pivot points 1522, 1524, respectively, causes a portion of the rotated magnetic wheels 1514, 1516 to move away from the surface 1600. In one implementation, as shown in FIG. 20, an outer portion of each wheel 1514, 1516 directed away from the center of the crawler 1502 moves away from the surface 1600. Since the strength of magnetic attraction between the magnetic wheels 1514, 1516 and the surface 1600 is inversely proportional to at least the distance between the magnetic wheels 1514, 1516 and the surface 1600, the rotation of the wheels 1514, 1516 about the pivot points 1522, 1524, respectively, causes a reduction in the magnetic coupling or adhesion of the wheels 1514, 1516 with the surface 1600. FIGS. 19-21 illustrate the rotation of the side members 1510, 1512, the arms 1518, 1520, and the magnetic wheels 1514, 1516 about the pivot points 1522, 1524, respectively, from the configuration of such side members 1510, 1512, the arms 1518, 1520, and the magnetic wheels 1514, 1516 shown in FIGS. 15 and 18. Accordingly, the configuration of the crawler 1502 with rotated magnetic wheels 1514, 1516, as shown in FIGS. 19-21, has a reduced magnetic coupling or adhesion of the crawler 1502 to the surface 1600, which facilitates removal of the crawler 1502 from the surface 1600.

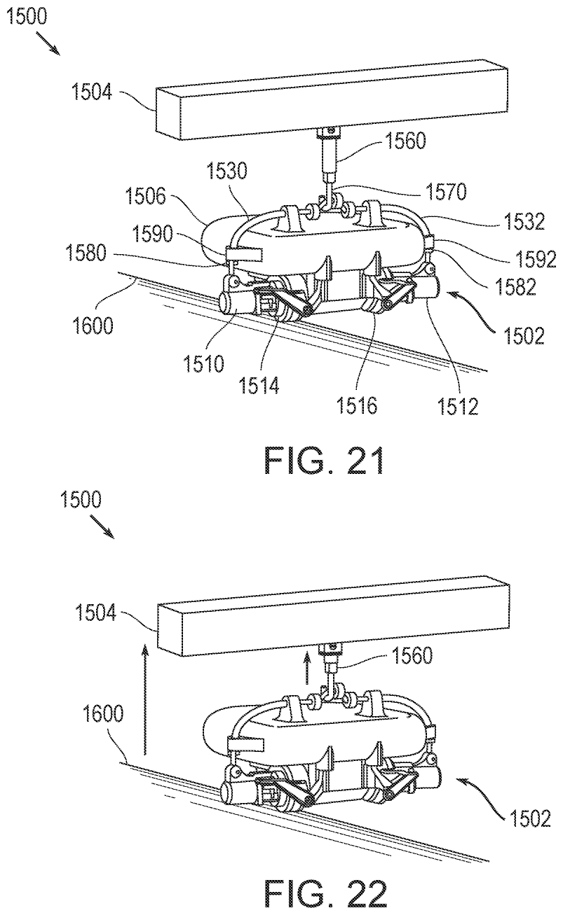

With the crawler 1502 in such a configuration in FIG. 21, the actuator 1560 lifts upward the fastener 1570 mechanically and removably coupled to the wire 1540, as shown by the upward arrow adjacent to the actuator 1560 in FIG. 22, to further weaken the magnetic coupling or adhesion of the wheels 1514, 1516 and the surface 1600. Since the rotated magnetic wheels 1514, 1516 have a reduced magnetic coupling or adhesion with the surface 1600, the entire crawler 1502 is readily detached from and lifted away from the surface 1600 by the platform 1504, as shown in FIG. 22. In an implementation, the apparatus 1500 with at least the platform 1504 is a UAV, allowing the apparatus 1500 with the crawler 102, detached from the surface 1600, to fly away from the surface 1600. The steps illustrated in FIGS. 16-22 and as described above are further described below in conjunction with the method 2300 having the steps of the flowchart illustrated in FIG. 23.

It is to be understood that the steps of detaching the crawler 1502 from the surface 1600 and attaching the crawler 1502 to the platform 1504 shown in FIGS. 16-22 are reversible to attach the crawler 1502 to the surface 1600 and to detach the crawler 1502 from the platform 1504. That is, the illustrated steps described above, proceeding from the configuration of the apparatus 1500 and the surface 1600 in FIG. 22 to the configuration of the apparatus 1500 and the surface 1600 in FIG. 16 are performed to attach the crawler 1502 to the surface 1600 and to detach the crawler 1502 to the platform 1504. The reverse progression of the steps illustrated in FIGS. 16-22 and as described above are further described below in conjunction with the method 2400 having the steps of the flowchart illustrated in FIG. 24.

In an implementation shown in FIG. 23, a method 2300 is configured to detach a crawler from a surface. The method 2300 includes moving a crawler along a surface of a structure toward a platform, with a magnetic wheel of the crawler magnetically coupled to the surface in step 2302. The method 2300 then engages a wire of the crawler and a fastener of the platform in a removable coupling in step 2304. The method 2300 then moves the removable coupling towards the platform using an actuator in step 2306, and moves the wire of the crawler to rotate an assembly including the magnetic wheel in step 2308. The method 2300 then tilts the magnetic wheel by rotation of the assembly to reduce the magnetic coupling or adhesion of the magnetic wheel to the surface in step 2310. The method 2300 then moves the removable coupling toward the platform using the actuator to move the crawler with the reduced magnetic coupling or adhesion away from the surface in step 2312, and moves the platform removably coupled to the crawler away from the surface in step 2314.

In an implementation shown in FIG. 24, a method 2400 is configured to attach a crawler to a surface, including providing a platform and a crawler with the platform having an actuator and a fastener, with the crawler having a magnetic wheel and a wire, with the platform removably coupled to the crawler by the fastener removably coupled to the wire in step 2402. The method 2400 then moves the platform to a position in proximity to a surface of a structure in step 2404, and moves the removable coupling of the fastener and the wire using the actuator to position the magnetic wheel in proximity to the surface in step 2406. The method 2400 then magnetically couples the magnetic wheel to the surface in step 2408, and moves the actuator to disengage the removable coupling of the fastener and the wire which couples the crawler to the platform in step 2410. The method 2400 then moves the crawler along the surface in a direction away from the platform to disengage the wire from the platform in step 2412.

It is to be understood that like or similar numerals in the drawings represent like or similar elements through the several figures, and that not all components or steps described and illustrated with reference to the figures are required for all embodiments, implementations, or arrangements.

The terminology used herein is for the purpose of describing particular implementations only and is not intended to be limiting of the invention. As used herein, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

While the disclosure has described several exemplary implementations, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to implementations of the disclosure without departing from the essential scope thereof. Therefore, it is intended that the invention not be limited to the particular implementations disclosed, or to the best mode contemplated for carrying out this invention, but that the invention will include all implementations falling within the scope of the appended claims.

The subject matter described above is provided by way of illustration only and should not be construed as limiting. Various modifications and changes can be made to the subject matter described herein without following the example embodiments, implementations, and applications illustrated and described, and without departing from the true spirit and scope of the invention encompassed by the present disclosure, which is defined by the set of recitations in the following claims and by structures and functions or steps which are equivalent to these recitations.

What is claimed is:

1. A crawler configured to move along a surface of a structure, comprising:
a body including:
a wire having a pair of ends; and
a pair of pivot points;
a pair of wheels, wherein each wheel includes:
an axle; and
an outer surface having a magnetic component and configured to move adjacent to the surface of the structure, wherein the magnetic component establishes a magnetic adhesion of a respective wheel to the surface of the structure; and
a pair of side members, wherein each side member is coupled to a respective end of the wire, wherein each side member is coupled to a respective axle of a respective wheel, and wherein each side member is pivotally coupled to a respective one of the pivot points,
wherein, responsive to a device moving the wire away from the surface of the structure in a first movement, the pair of side members pivot about the respective pivot points to pivot the respective axle,
wherein, responsive to the pivoting of each axle, a portion of the outer surface of one of the pair of wheels corresponding to the respective axle pivots away from the surface of the structure, thereby reducing the magnetic adhesion of the wheel to the surface of the structure, and
wherein, responsive to the device moving the wire away from the surface of the structure in a second movement, the device overcomes the reduced magnetic adhesion and detaches at least one of the pair of wheels from the surface of the structure to allow removal of the crawler from the surface of the structure.

2. The crawler of claim 1, wherein the wire is configured to removably couple to a fastener of the device using a mechanical coupling or a magnetic coupling.

3. The crawler of claim 2, wherein a movement of the fastener moves the wire in the first movement, thereby pivoting the pair of side members about the respective pivot points to pivot the respective axles.

4. The crawler of claim 1, wherein the wire includes a pair of wires,
wherein one end of each wire is mounted to the body,
wherein the other end of each wire is coupled to a respective side member,
wherein, responsive to the device moving at least one of the pair of wires away from the surface of the structure in the first movement, at least one of side members pivots about a respective pivot point to pivot the respective axle.

5. The crawler of claim 1, wherein the body includes a wire guide configured to receive and pass the wire through the wire guide.

6. The crawler of claim 5, further comprising:
a mounting member configured to retain the wire guide.

7. The crawler of claim 1, further comprising:
a pair of wire stoppers each retained by a respective wire of the pair of wires, including a strained wire and a loose wire, with each of the strained wire and the loose wire is associated with a respective side member and a respective wheel, and
wherein, responsive to the device moving the strained wire away from the surface of the structure in the second movement, the device overcomes the reduced magnetic adhesion and detaches the wheel associated with the strained wire from the surface of the structure to allow removal of the crawler from the surface of the structure.

8. The crawler of claim 7, wherein, responsive to the device moving the wire away from the surface of the structure in a third movement, the side member associated with the loose wire pivots about a respective pivot point to pivot the respective axle, thereby pivoting the portion of the outer surface of the respective wheel corresponding to the respective axle to pivot away from the surface of the structure, thereby reducing the magnetic adhesion of the respective wheel to the surface of the structure.

9. An apparatus, comprising:
a platform including:
an actuator having:
a base; and
a telescoping member configured to extend from or retract into the base;
a crawler configured to move along a surface of a structure, including:
a body including:
a wire having a pair of ends; and
a pair of pivot points;
a pair of wheels, wherein each wheel includes:
an axle; and
an outer surface having a magnetic component and configured to move adjacent to the surface of the structure, wherein the magnetic component establishes a magnetic adhesion of a respective wheel to the surface of the structure; and
a pair of side members, wherein each side member is coupled to a respective end of the wire, wherein each side member is coupled to a respective axle of a respective wheel, and wherein each side member is pivotally coupled to a respective one of the pivot points,
wherein, responsive to the actuator moving the wire away from the surface of the structure in a first movement, the pair of side members pivot about the respective pivot points to pivot the respective axle,
wherein, responsive to the pivoting of each axle, a portion of the outer surface of one of the pair of wheels corresponding to the respective axle pivots away from the surface of the structure, thereby reducing the magnetic adhesion of the wheel to the surface of the structure, and
wherein, responsive to the actuator moving the wire away from the surface of the structure in a second movement, the actuator overcomes the reduced magnetic adhesion and detaches at least one of the pair of wheels from the surface of the structure to allow removal of the crawler from the surface of the structure.

10. The apparatus of claim 9, wherein the wire is configured to removably couple to a fastener of the actuator using a mechanical coupling or a magnetic coupling.

11. The apparatus of claim 10, wherein a movement of the fastener moves the wire in the first movement, thereby pivoting the pair of side members about the respective pivot points to pivot the respective axles.

12. The apparatus of claim 9, wherein the wire includes a pair of wires,
wherein one end of each wire is mounted to the body,
wherein the other end of each wire is coupled to a respective side member,
wherein, responsive to the actuator moving at least one of the pair of wires away from the surface of the structure in the first movement, at least one of side members pivots about a respective pivot point to pivot the respective axle.

13. The apparatus of claim 9, wherein the body includes a wire guide configured to receive and pass the wire through the wire guide.

14. The apparatus of claim 13, further comprising:
a mounting member configured to retain the wire guide.

15. The apparatus of claim 9, further comprising:
a pair of wire stoppers each retained by a respective wire of the pair of wires, including a strained wire and a loose wire, with each of the strained wire and the loose wire is associated with a respective side member and a respective wheel, and
wherein, responsive to the actuator moving the strained wire away from the surface of the structure in the second movement, the actuator overcomes the reduced magnetic adhesion and detaches the wheel associated with the strained wire from the surface of the structure to allow removal of the crawler from the surface of the structure.

16. The apparatus of claim 15, wherein, responsive to the actuator moving the wire away from the surface of the structure in a third movement, the side member associated with the loose wire pivots about a respective pivot point to pivot the respective axle, thereby pivoting the portion of the outer surface of the respective wheel corresponding to the respective axle to pivot away from the surface of the structure, thereby reducing the magnetic adhesion of the respective wheel to the surface of the structure.

17. A method, comprising:
moving a crawler along a surface of a structure, wherein the crawler includes a magnetic wheel magnetically adhering to the surface;
engaging a wire of the crawler and a fastener of a platform in a coupling;
moving the coupling of the wire and the fastener towards the platform;
responsive to the moving of the wire in the coupling, moving a portion of the magnetic wheel away from the surface of the structure, thereby reducing the magnetic adhesion of the magnetic wheel to the surface of the structure; and
moving the combination of the crawler and the platform away from the surface of the structure.

18. The method of claim 17, wherein the coupling of the wire and the fastener is a removable coupling.

19. The method of claim 17, wherein moving the portion of the magnetic wheel away from the surface of the structure includes tilting the magnetic wheel about a pivot point.

20. The method of claim 17, wherein moving the coupling of the wire and the fastener towards the platform includes retracting a telescopic member of an actuator, wherein the fastener is attached to an end of the telescopic member.
